(19) United States
(12) Patent Application Publication
(10) Pub. No.: US 2006/0228094 A1
(43) Pub. Date: Oct. 12, 2006

(54) Method for manufacturing beam-shaping components

(75) Inventors: Ilkka Antero Alasaarela, Oulu (FI); Mikko Petteri Alasaarela, Oulu (FI); Teuvo Kalevi Viljamaa, Oulu (FI)

Correspondence Address: HARRINGTON & SMITH, LLP, 4 RESEARCH DRIVE, SHELTON, CT, 06484-6212, US

(73) Assignee: Upstream Engineering Oy

(21) Appl. No.: 11/400,328

(22) Filed: Apr. 6, 2006

Related U.S. Application Data
(60) Provisional application No. 60/669,465, filed on Apr. 8, 2005.

(51) Int. Cl. G02B 6/00

(52) U.S. Cl. 385/147

(57) ABSTRACT

A method for manufacturing an optical component includes mounting each of a series of replicating inserts to a movable support such as a mold slide. Each of the replicating inserts defines a replicating surface that bears micro-optical structures. Each of the supports is moved relative to one another so that the replicating surfaces of the inserts form at least portions of surfaces of a concave geometric shape. An optically transmissive substrate is then disposed between the replicating surfaces, so that the micro-optical structures of the replicating surfaces are impressed upon externally-facing surfaces of the optically transmissive substrate. Each of the mold slides are then moved away from the externally facing surfaces of the optically transmissive substrate, in a direction that is selected to preserve the impressed micro-optical structures.

### CROSS REFERENCE TO RELATED APPLICATION

This application claims priority to U.S. Provisional Patent Application No. 60/669,465, filed on Apr. 8, 2005 and entitled “Method for Manufacturing Beam-Shaping Components”. That priority application is herein incorporated by reference.

### FIELD OF THE INVENTION

The present invention relates to a method for manufacturing optical beam-shaping components, preferably by injection molding.

### DESCRIPTION OF THE RELATED ART

Optical beam shaping components manipulate light from a source, such as a light-emitting diode (LED). Often, the LED used with beam shaping components is comprised of a piece of semiconductor (called an LED chip) mounted on a heat sinking substrate, the means for supplying electricity to the semiconductor (typically by wire leads), and a package which is typically a transparent dome with an advantageous refractive index, inside which the LED chip is encapsulated.

Encapsulating a light-emitting diode inside a transparent, high refractive index material such as the transparent dome provides advantages such as durable packaging for the semiconductor and the wire leads, increased external efficiency of the LED chip, and enables a designer to modify the radiation pattern emanating from the beam shaping component by shaping the dome so that it performs certain optical functions. Epoxy resin and silicone are typical materials used for encapsulation.

Typical shapes for domes are half sphere, half ellipsoid and flattened half sphere. In some cases it is beneficial to use a more complex shape that performs more sophisticated beam-shaping functions. U.S. Pat. No. 6,598,998 B2, for example, describes one such more complex shape, which transforms the Lambertian radiation pattern of the LED chip into a side-emitting pattern.

Shapes that are even more complex and optical functions that are even more complex can be obtained by including micro-optical structures on the surface of the dome. These micro-optical structures include refractive or diffractive optical structures. For example, international patent WO 99/25031 proposes the forming of a diffractive optical element on and integral with the surface of the dome by injection molding. The use of micro-optical structures provides advantages in many applications but micro-optical structures are also more difficult to manufacture.

Beam shaping components that employ micro-optical structures are typically circularly symmetric because circularly symmetric optical components are relatively easy to manufacture with existing manufacturing methods. The LED package and light emitting device of U.S. Pat. No. 6,5908,998 and WO 99/25031 are seen as circularly symmetric about the optical axis. In a circularly symmetric optical device, the optical axis forms a central longitudinal axis of the device whose cross sections, perpendicular to that optical axis, are circular. Diamond turning or CNC precision turning can be used to form the shape of the dome with micro-optics. These are relatively expensive manufacturing methods, but when they are used to manufacture a tool, which is then used in injection molding, embossing or casting, the unit cost may be reduced substantially.

However, circularly symmetric structures can only produce cylindrically symmetric optical functions, which is not ideal in many applications and results in light losses and decreased brightness. One of the common problems occurs when a rectangular area needs to be illuminated with a circularly symmetric component. Typically the illuminated area is circular so all the light that is inside that circular area but outside the rectangular area is lost. In many cases such as with micro-scale devices, this inefficiency is not easily compensated by increasing power at the light source, due to battery constraints or heat management.

Another method for fabricating micro-optical structures is to manufacture them on flat substrates using lithographical methods or linear ruling. Because of that, there is another group of proposed beam-shaping domes around an LED chip. These propositions comprise a cylindrical or truncated inverted cone shaped dome; common to all of these is that the top surface is planar and comprises micro-optical structures. These can be manufactured by using a planar plate containing the micro-optical structures as a mold insert or an embossing tool. This is proposed in international patent WO 2004/044995 A1, for example, which is also seen as circularly symmetric. What is needed is a method to efficiently manufacture beam shaping components that can provide a rectilinear illumination without the losses incurred, as noted above, when the illumination from the component is not rectilinear.

### SUMMARY OF THE INVENTION

In accordance with one aspect of the invention, a method for manufacturing an optical component includes mounting each of a series of at least three replicating inserts to a movable support, such as a mold slide. Each of the replicating inserts defines a substantially planar replicating surface that bears micro-optical structures. Each of the movable supports are moved relative to one another so that the replicating surfaces of the inserts form at least portions of surfaces of a concave geometric shape. An optically transmissive substrate is then disposed between the replicating surfaces, so that the micro-optical structures of the replicating surfaces are impressed upon externally-facing surfaces of the optically transmissive substrate. Each of the movable supports are then moved away from the externally facing surfaces of the optically transmissive substrate, in a direction that is selected to preserve the impressed micro-optical structures.

In accordance with another aspect, the invention is a method for making an optical component that includes forming a plurality of micro-optical structures on a first surface of at least a first mold slide. Each of the plurality of micro-optical structures defines a maximum height of 100 microns. Next, the first mold slide is disposed in relation to a molding apparatus in such a manner that the first surface and the molding apparatus together define a concave geometric shape. An optically transmissive substrate is then disposed within the concave geometric shape to contact the first surface, so that the micro-optical structures on the first surface are impressed upon an optical surface of the substrate. The first mold slide is then moved relative to the substrate in a direction that preserves the micro-optical structures that have been impressed upon the optical surface of the substrate.

Other features and more details of the various aspects of the methods of this invention are detailed further below.

### BRIEF DESCRIPTION OF THE DRAWINGS

FIG. 1A. is a cutaway plan view of a replicating tool being removed along a first direction from a substrate upon which exaggerated micro-optical structures are formed.

FIG. 1B is similar to FIG. 1A, but the replicating tool is being moved along a second direction away from the substrate.

FIG. 1C is similar to FIG. 1A, but the replicating tool is being moved along a third direction away from the substrate.

FIG. 2A. is a perspective view of a truncated four-sided pyramid shaped substrate having a cavity.

FIG. 2B is similar to FIG. 2A, but a sectional view and with a LED and optical fill material disposed to partially fill the cavity.

FIG. 3A. is a schematic view of a master plate bearing micro-optical areas.

FIG. 3B shows steps in making multiple replicating inserts from a master plate.

FIG. 4A is a sectional view of a mold with mold slides, replicating inserts, and a concave shape into which a substrate is disposed.

FIG. 4B is similar to FIG. 7A, but showing the mold opened and the formed substrate extracted.

FIGS. 5A-5B are similar to FIGS. 4A-4B, but where an insert for the top surface of the substrate is fixed to an upper portion of the mold.

FIGS. 6A-6B are similar to FIGS. 4A-4B, but showing hinged mold slides for the sidewall surfaces of the substrate.

FIG. 7A is a perspective view of an upper mold portion adapted for forming an optional collar on a substrate.

FIG. 7B is a sectional view of a substrate having a collar, made from the upper mold portion of FIG. 7A.

FIGS. 8A-8C are similar to FIG. 2B, but showing variations in LED, optical fill material, and base substrate.

FIG. 9A show a series of perspective views for various geometric shapes into which the optically transmissive substrate may be formed according to the invention.

FIG. 9B show sectional views of a mesa-shaped substrate with various shaped cavities.

FIGS. 10A-10B show sectional and perspective views of a substrate with four lenses impressed in its top surface.

FIGS. 11A-11B show various configurations to space the optically transmissive substrate from the LED so as to allow different optical cones through the substrate.

FIG. 12 is a top view of the truncated four-sided pyramid of FIG. 2A, showing measurement features.

### DESCRIPTION OF THE PREFERRED AND ALTERNATIVE EMBODIMENTS

This disclosure and claims use the terms micro-optical structure and microstructure to refer to a broad array of optical apparatuses that are used to purposefully manipulate light using structures that are less than about 1 millimeter, and typically less than 250 microns, in size. Exemplary but non-limiting optical apparatus amenable to manufacture by the methods disclosed herein are described in co-pending and co-owned U.S. patent application Ser. No. 10/622,296, filed on Jul. 17, 2003 and entitled “2D/3D Data Projector” (now allowed). Micro-optical structures are manufactured on a planar or curved area, in some embodiments covering the entire surface, so that the structures form fine structure over the macroscopic surface. The height of the micro-optical structures can vary from 100 nm to 1 mm, but typically vary from about 500 nm to 100 microns. Diffractive micro-optical structures are typically less than 2 microns in height, and refractive micro-optical structures are typically more than 1 micron in height. The structures consist of details with better than ten micron resolution, typically better than 3 micron resolution. The planar or curved area that is covered with the micro-optical structures is typically much larger in its diameter than the features in the micro-optical structures. The micro-optical structure can be periodic, in which case the same micro-optical features repeat over the macroscopic surface area. Alternatively the micro-optical structure can be unperiodic. Examples of micro-optical structures include refractive micro-prisms, micro-lenses, Fresnel lenses, diffraction gratings of various types, and other such physical structures, or arrays or combinations of these.

An important advantage of planar micro-optics over cylindrically symmetric micro-optics is that by using lithographical manufacturing methods the micro-optical structures can include a wide variety of different forms, which are not limited to any rotational symmetry, for example. However, having all the micro-optical structures in one plane, as in the prior art, is a severe restriction. In many cases the light emitted from the LED chip to the sides are lost partially or wholly. In some other solutions the light emitted to the sides is reflected by extra mirrors upwards, which adds one more optical surface to the system thus adding complexity, increasing the width of the component and increasing possible losses.

The major barrier to developing new, sophisticated forms of beam-shaping components is the lack of feasible manufacturing methods that would enable complex micro-optical structures without severe geometrical form restrictions to be manufactured around a LED chip in such a manner that the micro-optical structures essentially cover a hemisphere.

An object of this invention is to provide a method for manufacturing beam-shaping components comprised of micro-optics around light emitting diodes, which provides the following advantages:
mass production at a low price
possibility to essentially cover a whole hemisphere about a light source with micro-optical structures
the micro-optical structures can have very versatile geometrical forms without any obligation to have linear or cylindrical symmetry
it is possible to fill the space between the LED source and the micro-optical structures with high refractive index material.

As mentioned above, micro-optical structures can usually be manufactured on flat substrates (host structures) only, and that represents the most efficient means by which to make them. Manufacturing methods on flat substrates allow the most versatile geometrical forms for microstructures, too.

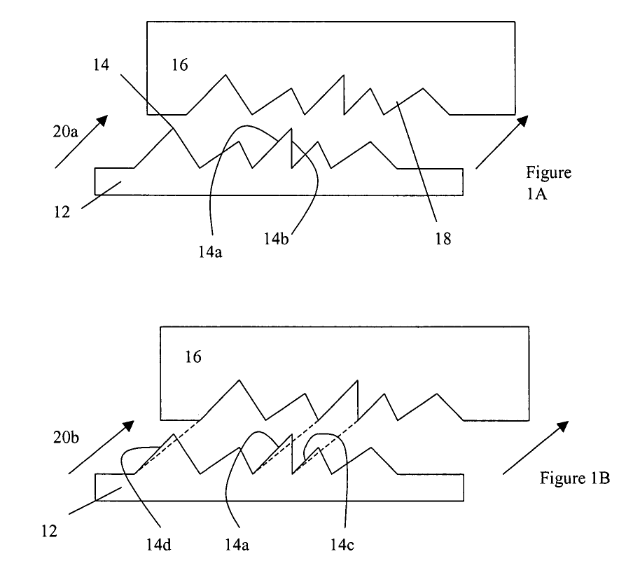

Another important matter regarding the replication of micro-optical structures by injection molding, compression injection molding, or embossing is the direction where the replication tool is moved when extracting the tool out of the replica. The extraction direction substantially restricts the geometrical forms that can be formed with the tool. FIG. 1A shows a surface with microstructures 102 and a replication tool 104 above it. Possible extraction directions depend on the exact form of the microstructure. Typically the optimal direction is perpendicular to the generalized surface of the substrate on which the micro-structures are formed, especially when the microstructure consists of a wide variety of shapes, for example a lot of microprisms in various orientations, or diffractive optical structures. Also, when the replication tool is manufactured by a lithographical process, the optimal direction is the plane normal.

The sliding direction restricts the shapes of the micro-optical structures that can be formed, or conversely, the shapes of those structures restrict the sliding direction. FIGS. 1A-1C show a substrate 12 having a surface 14 onto which micro-structures are formed, such as from being embossed by a replicating tool 16 having a structure-defining surface 18. The scale of the micro-structures is greatly exaggerated in FIGS. 1A-1C to illustrate a particular concern in manufacturing such substrates 12, and movement of the replicating tool 16 is a concern only in the immediate vicinity of the surface 14 bearing the micro-optical structures. If the replicating tool 16 is extracted away from the substrate 12 in a first direction 20a, the substrate surface 14 bearing the micro-structures is not deformed by the movement away. Immediate vicinity is taken to mean a distance that is at least equal to the height between the tallest peak and deepest trench of the micro-optical structures across either of the mating surfaces 14 or 18 (which should be the same height absent manufacturing discrepancies).

The first direction 20a is any direction that is parallel to or more normal to the average planarized surface of the substrate nearest that replicating tool 16 than a critical surface 14a of the micro-optical structures. The critical surface 14a is that surface nearest the vertical and within the same 90 degree sweep between the vertical and horizontal as the slide (first) direction 20a. For example, taking the normal/vertical as 90 degrees, a rightward extending horizontal vector as zero degrees and a leftward extending horizontal vector as 180 degrees, then the first direction 20a as illustrated is parallel to the critical surface 14a because that critical surface is nearest the vertical and within the 0-90 degree sweep of the first direction 20a. If the replicating tool 16 were moved away from the substrate 12 with a leftward component, the slide direction would be nearly vertical because the critical surface 14b (assummed to have an inclination of slightly greater than 90 degrees) is nearly vertical for the opposite 90-180 degree sweep that a leftward moving replicating tool would slide.

Conversely and as shown in FIG. 1B, if the replicating tool 16 is moved away from the substrate 12 in a second direction 20b that is less than the direction defined by the critical surface 14a, then at least that critical surface 14a and possibly other surfaces 14c, 14d will be deformed by the structure-defining surface 18 of the replicating tool 16.

It is clear that acceptable directions for moving the replicating tool 16 away from the substrate 12, after formation of the micro-optical structures on the substrate surface 14, is defined by the nature of the micro-optical structures themselves. Typically, the replicating tool 16 is generally an insert that has the requisite micro-optical structures mounted to a movable support, and the assembly moves along mechanical slide apparatus that move it in a linear manner, at least in the immediate vicinity of the substrate 12. In injection molding, mold slide is a term denoting a moving machine part that is used to create such features in the molded parts that might require undercuts in the molds. Such features are wall holes for example. In replication by injection molding the movable support can represent a mold slide carrying the insert. In replication by embossing, the movable support can represent a stamper carrying the insert with micro-optical structures. As used herein, the term mold slide means one or more movable supports which may take any number of different forms, the exact form depending on the main replication method used.

One benefit enabled by this invention is that the extraction direction can be chosen almost freely, thus permitting the extraction of the replicating tool 16 towards the direction of the surface normal, for example. While the (exaggerated) surface 14 bearing the micro-optical structures is not truly planar, we consider its average plane to be the planar or substantially planar surface when considering the direction of relative movement between the replicating tool 16 and the optically transmissive substrate 12. FIG. 1C shows the replicating tool 16 moving in the normal/vertical direction 20c to an average planarized surface of the substrate 12.

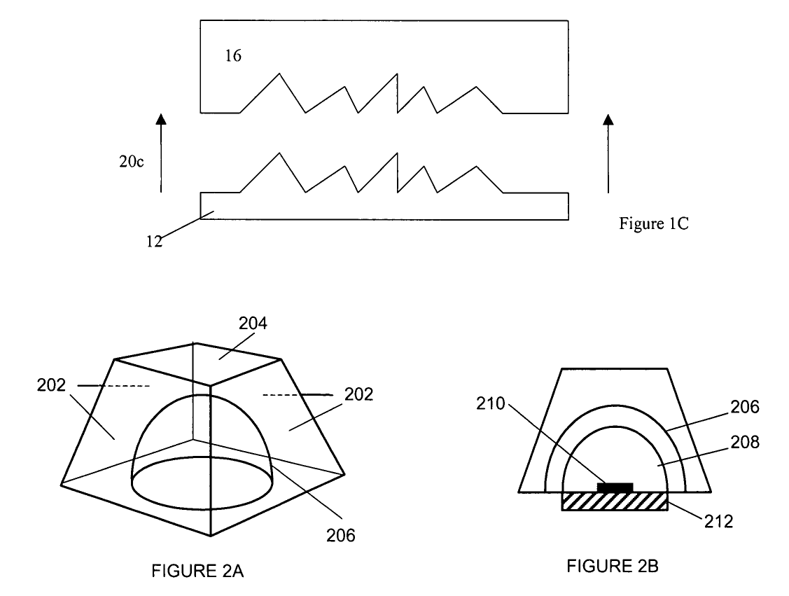

One manufacturing method according to the invention is now described by using an exemplary beam shaping component to be manufactured, as shown in FIG. 2A. The outer shape of the illustrated component is a truncated four-sided pyramid, i.e. a mesa with four side facets 202 and one top facet 204. Inside the component there is a hemispherical hollow space or cavity 206. All of the side facets 202 and the top facet 204 define micro-optical structures formed in an optically transmissive substrate. FIG. 2B presents how a LED component 208, that includes an LED chip 210 on a mirrorized substrate 212, is assembled with the component so that the LED chip 210 is inside the hollow cavity 206. Thus the whole hemisphere around the chip 210 is covered with micro-optical structures enabling very complex beam-shaping functions to be performed efficiently and in a very compact space, such as where the outer shape of the component measures an inch or less one each side. As will be described, the present method enables efficient manufacture of various shapes for the optically transmissive substrate 12.

One manufacturing method of the invention includes the following manufacturing steps: mold manufacturing, injection molding and assembling.

In an embodiment, the mold manufacturing includes micro-optical master manufacturing, electroforming the master in order to get a metal replica of the inverted master, cutting the metal replica to get the replicating inserts, providing slides for the mold, fixing or bonding the replicating inserts onto mold slides, providing the upper part of the mold where the slides are arranged to form a mesa-shaped cavity, and providing the lower part of the mold. Typically, multiple replicating inserts are made from a single master. It is the replicating inserts that are used to actually form the micro-optical structures on the optically transmissive substrates 12 used for individual beam shaping components. Of course, the master itself may be used as a replicating insert to form the structures on the substrate directly (where the master is made to bear an inverted set of micro-optical structures ultimately desired for the substrate itself), but the following description assumes a more efficient mass-production method that uses replicating inserts made from one master or possibly several identical masters.

The micro-optical master, or master wafer, is manufactured by using binary or gray-scale masks, which enables complex structures to be formed on a planar glass or silicon wafer substrate by, e.g., photoresist process or photoresist process followed with reactive ion etching. In another embodiment of the invention, instead of a mask, direct e-beam, laser writing, or a digital exposure device is used to expose the resist material. Still in another embodiment of the invention the micro-optical master is manufactured by using a one-, two- or three photon polymerization process. In addition to these processes mentioned, there are also other lithographical manufacturing processes or laser milling, micromachining, diamond turning, diamond ruling or other processes known in the art which can be used.

In electroforming, or electroplating as it is sometimes called, the master wafer is replicated to a replicating plate, which is typically nickel, or a nickel alloy for example. Typically some galvanic process is used. As is known in the art of electroforming, it is possible to electroform several generations from the same structure, so the original master wafer can be copied to multiple metal plates consisting of the same micro-optical structures as the original master or the inverse of it.

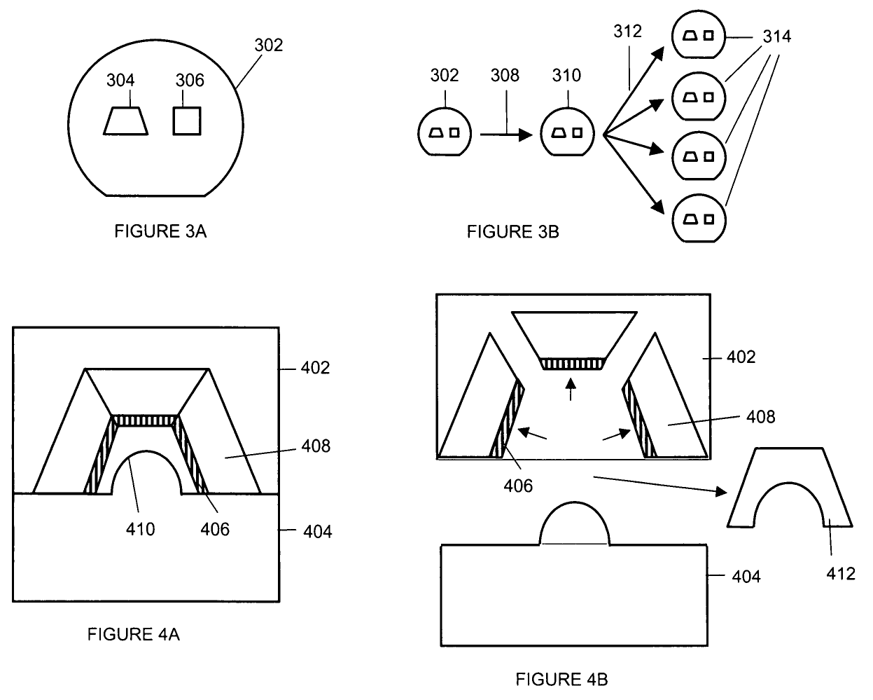

FIG. 3A shows the master wafer 302 used to manufacture the replicating wafers and inserts. The micro-optical areas 304 and 306 correspond to the sidewall facets 202 and top facet 204 respectively of FIG. 2A. In this exemplary embodiment all of the sidewall facets 202 will have identical micro-optical structures, within manufacturing precision tolerances, since they are made in this example from only one area 304 of the master wafer 302. However, the method of the invention allows each side facet 202 to have different micro-optical structures as well, such as where the different sidewalls derive from different areas of the master wafer 302.

FIG. 3B presents electroforming steps for creating multiple replicating plates for use in making a beam forming component. The master wafer 302 is electroformed 308 to the first generation plate 310, which contains the micro-optical structures of the master, but inverted. Next, the first generation plate 310 is electroformed four times 312 in order to get four second generation or replicating plates 314, which contain the same micro-optical structures as the master wafer 302. The replication process can be continued to third or more generations, and the amount of replicas per generation can be increased depending on how many copies are desired, and how well replication quality is preserved. Mastering processes are typically expensive compared to electroforming processes. Therefore when there are several similar micro-optical areas in one component, such as the four side facets in our exemplary component, it can be beneficial to manufacture only one master area 304, 306 for each arrangement of micro-optical structures and replicate it several times by electroforming. Another possibility is to manufacture several similar micro-optical areas into one wafer, depending on the mastering process used. For the embodiment of FIG. 2A, four replicating plates 314 are enough to create one set of replicating inserts for forming the substrate 12, with three areas 306 of the replicating plates 314 for the top facet as excess. However, it is possible and often necessary to electroform more generations and more plates per generation in order to get more insert sets out of one master.

After the micro-optical structures (in their desired or inverted state) have been copied onto the metal replicating plates 314, the areas with micro-optical structures are cut from the replicating plate as replicating inserts 316 for use in the mold. The cutting can be done by wire erosion, grinding, sawing, laser cutting, etching, water jet cutting, blade, shear or by some other sufficiently accurate method. In addition, the backside of the inserts (that surface opposite the replicating surface that bears the micro-optical structures) may be planarized and polished, roughened, or treated with some other surface treatment, which can be done by machining or grinding, for instance. The best surface treatment depends on the method used to fix or bond the inserts to the mold.

After the replicating inserts 316 are cut from the metal replicating plates 314, they are arranged inside the mold to form the mesa structure of FIG. 2A, or other desired geometric shape.

An innovative aspect of the method of the invention is that the upper part of the mold includes several mold slides, onto each of which an insert is fixed. In the preferred method, there is one slide for each substantially planar facet of the mesa-shaped substrate, enabling each slide to move the replicating insert that is fixed onto it towards and away from the relevant substrate surface along a critical direction (or more normal than the critical direction). In an embodiment, the replicating inserts are each moved normal to their relevant substrate surface, which is that surface of the beam-shaping component that their micro-optical structures are impressed upon. When the mold slides close and move the replicating inserts towards one another, replicating surfaces of the replicating inserts form the desired mesa shape or other concave geometric shape. Alternatively, the replicating surfaces may form only portions of the geometric shape, and other types of inserts or blanks may form the remainder. A lower portion of the mold may be disposed to enclose the concavity of the geometric shape.

The replicating inserts may fixed to the slides by bonding, gluing, welding, screwing or by any means which fixes them sturdily and accurately enough to be able to use in the mold.

FIG. 4A shows a sectional view of the overall mold used to manufacture the exemplary component in the closed position. The upper portion of the mold 402 forms the mesa shape and the lower portion of the mold 404 encloses the concavity of the mesa. The mesa is defined by five inserts 406 (those defining two sidewalls and a top surface shown in FIG. 4A) which are fixed on surfaces of five mold slides 408. The lower portion of the mold 404 also includes a protrusion 410 (domed hemisphere shown) which forms a hemispherical cavity within the mesa shaped substrate.

An optically transmissive substrate 412 is disposed between the mold slides 408 (and between the replicating surfaces of the inserts 406), which then takes on the mesa shape. Micro-optical structures of the replicating surfaces are thereby impressed upon the external planar surfaces of the optically transmissive substrate 412, or at least those external surfaces or portions of external surfaces that are contacted by the replicating surfaces of the inserts 406 having micro-optical structures.

FIG. 4B shows the same mold in an open position. Each mold slide 408 in the upper portion 402 has been moved outwards in the direction of the surface normal of the insert (shown by arrows). This allows the micro-optical structures of the inserts 406 to have a complex geometry. The upper portion 402 and the lower portion 404 of the mold have been moved apart from each other for extraction of the molded optically transmissive substrate 412 from the concavity defined (at least in part) by the replicating surfaces.

In one method, the substrate in fluid form is injected and hardened in place, such as by cooling, curing, or chemical solidification. The injection molding portion of the method includes closing the mold, filling the mold cavity with a plastic substrate material, opening the mold after the substrate material has been hardened, and extracting the formed optically transmissive substrate 412 out of the mold. In addition, injection molding can include additional steps, as known in the art, of which certain particular steps may depend on the exact form of the mold and the properties of the substrate material. Instead of typical injection molding process, compression injection molding can be used which improves the replication quality of micro-optical structures in some cases.

As known in the art, the mold can also comprise one or more injection channels through which the plastic substrate material is injected, air channels through which air and other gases can escape from the mold, cooling channels, ejector pins, and other features known and used in the injection molding arts.

Alternative to injection molding, a solid substrate material may be provided that is already formed in the mesa or other desired geometric shape. The micro-optical structures may be impressed on the external surfaces thereof by localized melting and solidification, or alternatively by pressure exerted by the mold slides 408 through the replicating inserts 406.

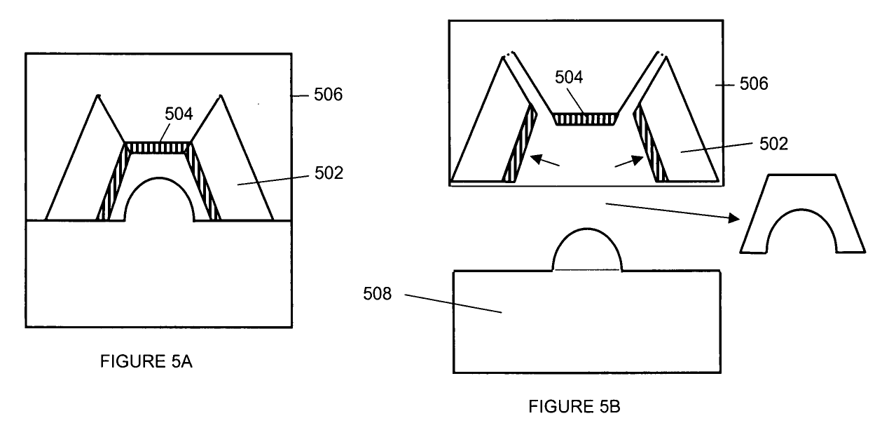

FIG. 5A shows another method for constructing the mold. Assuming the same component shapes as in FIGS. 4A-4B, there are only four mold slides 502 in FIGS. 5A-5B, one for each sidewall facet. A separate insert 504 for the top facet is fixed directly on the upper portion of the mold 506. Thus the insert 504 defining the top facet will move together with the upper portion of the mold. FIG. 5B shows the mold in an open position with the upper 506 and lower 508 portions separated from one another.

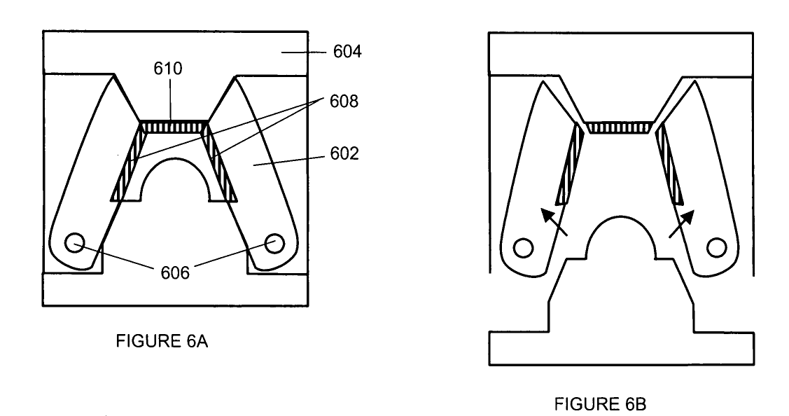

Still another method to construct the mold is to use mold slides with hinges. In that case the movement of the mold slides is rotational instead of linear. However because the critical separation distance between the replicating surfaces and the substrate is small (e.g., micro-optical structures having a height on the order of ranging from a few microns to a few tens of microns), the rotational movement is substantially a linear movement over that critical distance. FIG. 6A presents a mold structure where the mold slides 602 forming the sidewall facets have been joined to the upper portion of the mold 604 by hinges 606, and so provide the nearly perpendicular movement to the inserts 608 fixed to them, relative to the relevant facet of the substrate. The separate insert 610 for the top facet is fixed directly to the upper portion of the mold. FIG. 6B shows how the mold opens according to the arrows.

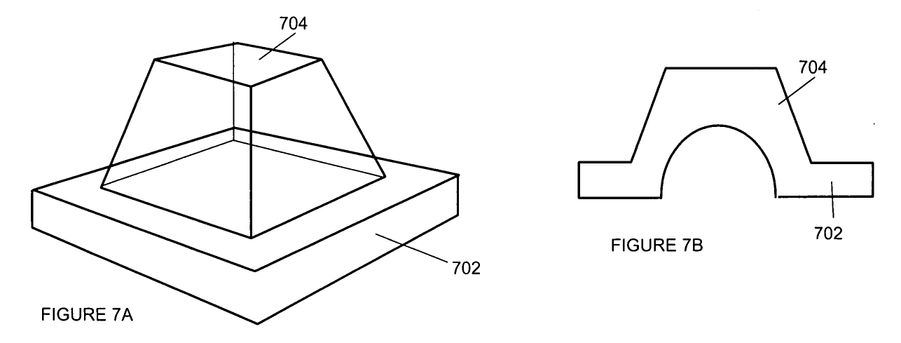

The mold can also form other shapes in addition to the mesa that has the beam-shaping function. For example as shown in FIGS. 7A and 7B, the mold can form a collar 702 around the mesa structure 704; this collar 702 can be used to fix the mesa to a substantially planar mounting substrate or some other base, or it can be used to fix and align other optical components with the mesa.

Further in a preferred method, one or more LED (or other light source) components are disposed inside the mesa cavity. The LED component or components can fill the cavity fully or partially. In the preferred method, the LED's themselves do not fill the cavity fully; rather there remains a space filled with optical fill material. The fill material has a suitable index of refraction according to the desired optical function, such as matching (e.g., within about 0.9 or even within about 0.4) an index of refraction of the light source chip. In another method, the remaining space is left empty, to achieve a different desired optical function. The LED component may be a bare LED chip, a packaged LED chip, or a package with several LED chips inside. It is an advantage of the manufacturing method of the invention that both bare chips and pre-encapsulated chips, or combinations of these, can be assembled inside the beam-shaping component. Another advantage of this manufacturing method is that it enables the use of a mounting substrate having a reflecting or mirrored surface adjacent to the LED chip so that the mirrored surface reflects the downwards-emitted light upwards towards the beam-shaping mesa structure and its externally facing surfaces that bear the micro-optical structures.

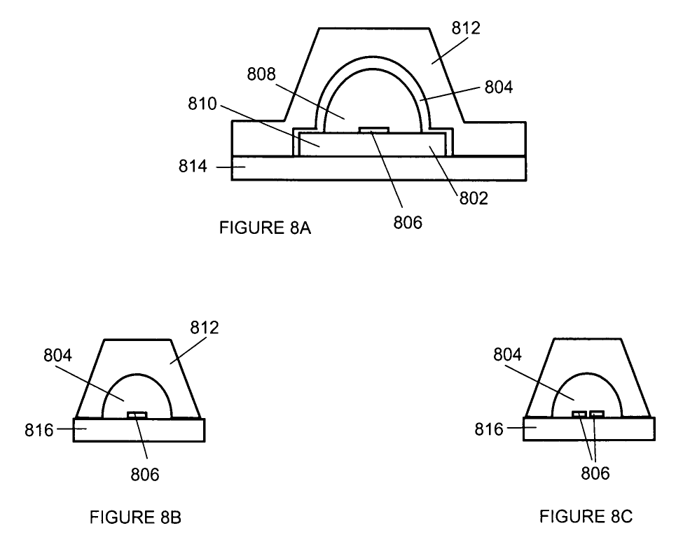

FIG. 8A shows an assembled beam-shaping component with one LED component 802 inside a cavity 804 defined by the optically transmissive substrate 812. The LED component 802 includes a LED chip 806 encapsulated inside a hemispherical dome 808, the dome 808 formed of an optical fill material, and a base 810. The LED component 802 and the mesa shaped substrate 812 are mounted on the same base substrate 814. FIG. 8B shows another assembled beam-shaping component where the LED component includes a bare LED chip 806. The LED chip 806 and the mesa shaped substrate 812 are mounted on the same base substrate 816. FIG. 8C shows an assembled beam-shaping component with two LED chips 806 inside its cavity 804. The base substrate 816 may be mirrored at least in the immediate vicinity of the LED chip 806. The cavity 804 may be filled with an optical fill material. In certain embodiments, the fill material (and/or the dome 808) exhibits an index of refraction that is matched (e.g., within about 0.4) to the index of refraction of the optically transmissive substrate 812.

The optical fill material disposed in the cavity can be plastic, liquid or gel. Preferably the fill material is silicone gel, which can be hard or soft. The fill material can also be air or some other gas, resin, epoxy, water or any material with an index of refraction in the range of 1.2 to 2.7, preferably between 1.3 and 1.8.

The machine that carries the molds (e.g., the upper and lower mold portions, the mold slides) for injection molding can be a conventional machine or, a micro-injection molding machine that preferably enables precise control of process parameters. There are a wide variety of plastics available for injection molding. Many of them can be used as the material for the substrate 812 to form the optical component (and/or the filler material). Transparent plastics known for optical uses include polycarbonate PC, polymethylmethacrylate PMMA, PC/PMMA, polyetherimide (PEI), polystyrene PS, styrene methyl-methacrylate copolymer NAS, styrene acrylinitrile SAN, cyclic olefin polymer, and cyclic olefin copolymer COC. Other exemplary materials include epoxy and silicone-based materials for example. The substrate material can have an index of refraction ranging from between 1.3 to 1.8, preferably between 1.51 and 1.59, but could have an index of refraction higher or lower based on the material used.

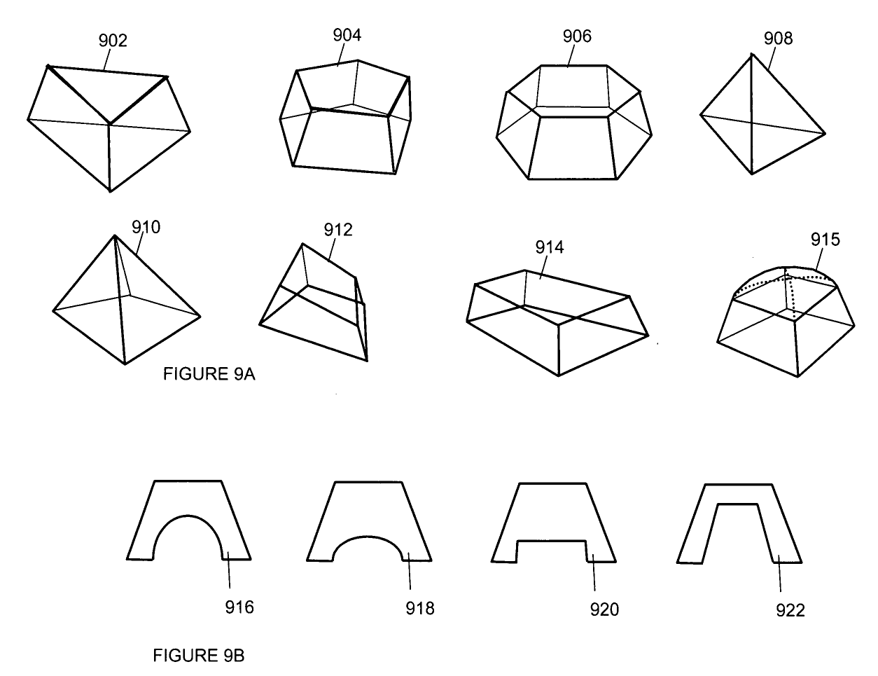

FIG. 9A illustrates several geometric shapes that can be manufactured with the method of the invention. Above, one method was described by using a symmetric truncated pyramid with four side facets as an exemplary mesa shape. The mesa shape can also be a truncated pyramid with three 902, five 904, six 906 or more side facets. The method can be used to manufacture optical beam-shaping components without a truncated top, such as a conventional non-truncated pyramid 908, 910. The mesa does not need to be symmetric; it can be any shape that at least partially consists of substantially planar facets or externally facing surfaces bearing the micro-optical structures and can be feasibly manufactured with the method described here. For example, the mesa can be a non-symmetrical truncated pyramid 912 or stretched four-sided truncated pyramid 914, or the mesa can consist of curved portions also 915.

The cavity inside the mesa can have different shapes as shown in FIG. 9B. It can be hemispherical 916, ellipsoidal 918, rectangular 920, mesa-shaped 922 or other variations, symmetric or otherwise. The concave surface(s) of the cavity can have an optical function, and work as a lens. Alternatively, those cavity surfaces can be made optically invisible by using a fill material whose refractive index matches that of the optically transmissive substrate used to form the mesa or other geometric shape.

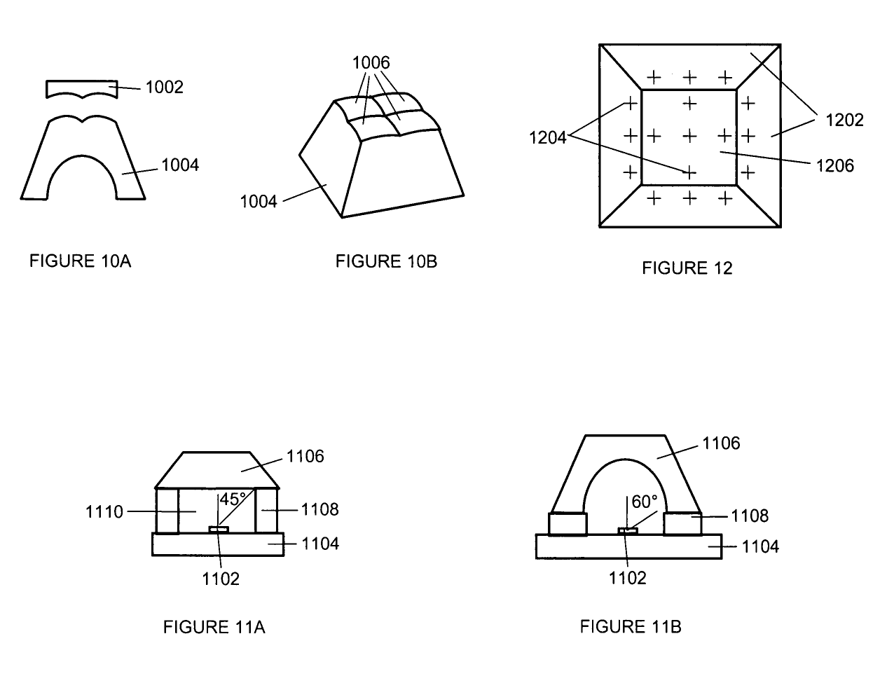

All of the inserts do not have to include micro-optical structures; they can contain the surface profile of a lens or lenses. For instance, some of the externally facing surfaces of the substrate may be formed to define one or more convex or concave lenses. A separate insert could also comprise both microstructures and lenses. FIGS. 10A and 10B present examples of how the separate insert 1002 for the top facet 1002 of a mesa shaped substrate 1004 could form four convex lenses 1006 onto the top facet of that optically transmissive substrate.

It is also possible to use inserts that are made by combining micro-optical structures from two or more masters. Combining can be made for example by using second generation nickel replicas. Areas with micro-optical structures can be cut from the replicas (for example by laser), and be combined next to each other on a planar substrate which can then be used as a master.

Although the exemplary component was manufactured by using inserts formed from a micro-optical master wafer, the same innovative method can also be implemented without the use of inserts by manufacturing the micro-structures directly on surfaces of the mold slides, for instance by diamond turning, precision CNC machining, laser milling, embossing or casting. In that case, the functions of the mold slide and insert are combined in a single component. For example, a replicating insert may be made from with abovementioned insert manufacturing process but so thick (for example 0.5-1.5 cm thick) and from such material (for example Nickel alloy) that the mold slide consisting the micro-optical structures can be machined directly out from the thick insert. Alternatively, instead of bonding the thin insert to the mold slide, the micro-optical structures may be cast or embossed directly on a surface of the mold slide by using the master or an identical replica.

For example, the micro-optical structures may be formed directly on a first surface of a mold slide by any of the methods noted immediately above. That mold slide may then be disposed in a molding apparatus, such as the upper mold portion previously described. In conjunction with other mold slides that may or may not also exhibit micro-optical structures the mold slide surfaces including the first surface with the micro-optical structures then define a concave geometric shape, such as the mesa or other shapes shown by non-limiting example in FIG. 9B. A substrate is disposed within the cavity formed by the concave geometric shape, and the micro-optical structures are impressed upon the substrate. This may be by injecting a liquid substrate and solidifying it within the cavity, by inserting a substrate having the general shape of the cavity and applying localized heating (e.g., electrical resistive heating of the mold slide first surface, conductive heating, microwave heating of the substrate itself, etc.) to impress the micro-optical structures, applying sufficient pressure by the mold slides with or without heating, and the like.

The methods of the invention enable the manufacturing of beam-shaping components in which the whole hemisphere seen from one or more LED components may be wholly covered with micro-optical structures. However, this ability must not be considered a restriction. The method also enables the manufacturing of beam-shaping components in which some other large solid angle is covered with microstructures. For example, the component can cover a cone with a half angle ranging from 30 to 90 degrees, advantageously from 30 to 60 degrees. When the light emitted to the whole hemisphere is not collected, the LED components need not be placed inside the cavity of the optically transmissive substrate but can be placed proximal to that substrate, in which case the optically transmissive substrate does not need to have a cavity for the light source chip. FIGS. 11A-11B illustrate different beam-shaping components that can be manufactured with the method of the invention.

FIG. 11A shows a beam-shaping component, the substrate 1106, which collects all the light emitted from a LED chip 1102 into a 45-degree (half angle) cone. The LED chip is mounted onto a base substrate 1104. The mesa-shaped beam-shaping component 1106, without a cavity, is spaced from the LED chip 1102 by a submount 1108. The volume 1110 between the base substrate 1104 and the mesa shaped substrate 1106 can be filled with an optical fill material, as noted above in the context of a cavity.

FIG. 11B shows a beam-shaping component which collects all the light emitted from an LED component 1102 into a 60-degree cone. The LED component 1102 is mounted onto a base substrate 1104, and the beam-shaping component 1106 is supported on the same base substrate 1104 via a submount 1108.

In a method of the invention, the micro-optical structures could define certain measurement features which can be used to help in alignment in mold manufacturing or component assembly, in addition to optical diffraction/refraction characteristics of those micro-optical structures. FIG. 12 shows a top view of a mesa shaped substrate in which each sidewall facet 1202 defines three measurement features 1204 and top facet 1206 defines five measurement features 1204. These measurement features can resemble alignment marks used in lithographical processes, and they can be helpful in e.g. verifying the quality of the micro-optical structures, the insert cutting, alignment of the replicating inserts and replicating surfaces, and in verifying the shape and quality of the replicating plates and inserts. These features 1204 and their relative positions can be measured by e.g. white light interferometers, profilometers, coordinate measurement devices etc. The measurement features 1204 can have a very wide range of different shapes, as known in the art for various optical and manufacturing purposes. Features 1204 can also be used for alignment purposes when assembling LED or other optical components with the component.

Those skilled in the art will appreciate that the method of the present invention may be used when manufacturing a wide range of optical components. While the present invention has been described in reference to exemplary preferred embodiments, the invention may be embodied in other specific forms without departing from the spirit of the invention. Accordingly, it should be understood that the embodiments described and illustrated herein are only exemplary and should not be considered as limiting the scope of the present invention. Other variations and modifications may be made in accordance with the spirit and scope of the present invention, and without departing from the ensuing claims.

What is claimed is:

1. A method for manufacturing an optical component, comprising:
mounting each of a series of at least three replicating inserts to a movable support, each of the replicating inserts defining a replicating surface that bears micro-optical structures;
moving each of the movable supports relative to one another so that the replicating surfaces form a concave geometric shape;
disposing an optically transmissive substrate between the replicating surfaces such that the micro-optical structures of the replicating surfaces are impressed upon externally-facing surfaces of the optically transmissive substrate; and
moving each of the movable supports away from the externally facing surfaces of the optically transmissive substrate in a direction selected to preserve the impressed micro-optical structures.

2. The method of claim 1 wherein at least one of the replicating surfaces that bears micro-optical structures is substantially planar.

3. The method of claim 1 wherein at least some of the replicating inserts are not parallel to each other when moved to form the concave geometric shape.

4. The method of claim 1 further comprising forming the series of replicating inserts from at least one master plate.

5. The method of claim 4 wherein forming the series of replicating inserts comprises forming a plurality of replicating plates from a master plate and cutting each of the series of replicating inserts from the plurality of replicating plates.

6. The method of claim 5, wherein cutting each of the series of replicating inserts from the plurality of replicating plates comprises wire erosion, grinding, sawing, laser cutting, water jet cutting, or etching.

7. The method of claim 4 further comprising creating micro-optical structures in the master plate using at least one of lithography, photon polymerization, electron beam writing, laser beam writing, laser milling, micromachining, diamond turning and diamond ruling.

8. The method of claim 1, wherein at least two of the replicating surfaces form at least portions of sidewall surfaces of the concave geometric shape, wherein the at least two of the replicating surfaces define identical micro-optical structures.

9. The method of claim 1, wherein the concave geometric shape comprises at least one top surface and a plurality of at least three sidewall surfaces, and a portion of each of said at least one top surface and at least three sidewall surfaces are formed by the replicating surfaces of separate replicating inserts.

10. The method of claim 1 wherein all externally facing surfaces of the concave geometric body are substantially planar, and wherein moving the movable supports relative to one another comprises moving the replicating inserts such that one insert is in contact simultaneously with all other replicating inserts to form the concave geometric shape.

11. The method of claim 1, wherein the concave geometric shape is defined by only substantially planar surfaces.

12. The method of claim 1, wherein the replicating surfaces form at least portions of sidewall surfaces of the concave geometric shape, and the movable supports are slideably mounted in a mold upper portion, and further wherein a separate insert that is fixed to the mold upper portion forms a top surface of the concave geometric shape adjacent to the sidewall surfaces.

13. The method of claim 1 wherein disposing an optically transmissive substrate between the replicating surfaces comprises injecting the substrate in fluid form between the movable supports and solidifying the substrate to fix the micro-optical structures on external surfaces of the solidified substrate.

14. The method of claim 1 wherein disposing an optically transmissive substrate comprises disposing a solid optically transmissive substrate defining the concave geometric shape between the movable supports prior to moving the movable supports relative to one another.

15. The method of claim 1 wherein disposing an optically transmissive substrate between the replicating inserts comprises defining a cavity within the substrate at least partially enclosed by the externally facing surfaces of the substrate.

16. The method of claim 15, further comprising disposing one or more light sources within the cavity of the optically transmissive substrate.

17. The method of claim 16, further comprising enclosing the cavity with a substantially planar substrate that defines a reflective surface facing the interior of the cavity.

18. The method of claim 16 wherein disposing a light source within the cavity of the optically transmissive substrate and enclosing the cavity with a substantially planar substrate are within a combined step of disposing a light source that is both embedded in the optical fill material and mounted to the substantially planar substrate.

19. The method of claim 16, further comprising injecting an optical fill material into the cavity so as to substantially fill the cavity.

20. The method of claim 19, wherein the optical fill material is plastic, liquid, gas, or hard or soft gel.

21. The method of claim 19, wherein the optical fill material and the optically transmissive substrate each define an index of refraction between about 1.2 and 2.7.

22. The method of claim 19, wherein the optical fill material and the optically transmissive substrate each define an index of refraction between about 1.3 and 1.8.

23. The method of claim 19, wherein the optical fill material and the optically transmissive substrate each define an index of refraction between about 1.51 and 1.59.

24. The method of claim 16 wherein the cavity defines a shape that is not substantially identical to a shape defined by the externally facing surfaces of the optically transmissive substrate.

25. The method of claim 16, wherein at least one surface that defines the cavity is adapted to operate an optical function on light emitted from the light source.

26. The method of claim 25, wherein the at least one surface that defines the cavity operates as a lens.

27. The method of claim 1, wherein moving each of the movable supports away from the externally facing surfaces of the optically transmissive substrate comprises hingedly moving at least those movable supports whose replicating surfaces form at least portions of sidewall surfaces of the concave geometric shape.

28. The method of claim 1, further comprising mounting a lens defining insert to a separate movable support,
wherein the replicating surfaces form at least portions of sidewall surfaces of the concave geometric shape and the lens defining insert forms at least a portion of a top surface of the concave geometric shape, said top surface adjacent to each of the sidewall surfaces.

29. The method of claim 1, wherein the transmissive substrate comprises at least one of polycarbonate PC, polymethylmethacrylate PMMA, PC/PMMA, polyetherimide PEI, polystyrene PS, styrene methyl-methacrylate copolymer NAS, styrene acrylinitrile SAN, cyclic olefin polymer, cyclic olefin copolymer COC, epoxy, and silicone.

30. The method of claim 1, wherein at least one of the replicating inserts defines at least one measurement feature for at least one of qualitative analysis of micro-optical structures, alignment of the replicating inserts with the movable supports, and qualitative analysis of the substrate after the at least one measurement feature is impressed on the substrate.

31. A method for making an optical component, comprising:
forming a plurality of micro-optical structures on a first surface of at least a first mold slide, said plurality of micro-optical structures defining a maximum height of 100 microns;
disposing the first mold slide in relation to a molding apparatus such that the first surface and the molding apparatus together define a concave geometric shape;
disposing an optically transmissive substrate within the concave geometric shape such that the micro-optical structures on the first surface are impressed upon an optical surface of the substrate; and
moving the first mold slide in relation to the substrate in a direction that preserves the micro-optical structures that are impressed upon the optical surface.

32. The method of claim 31 wherein forming a plurality of micro-optical structures on the first surface comprises at least one of embossing and casting.

33. The method of claim 31, wherein each of the plurality of micro-optical structures on the first surface define a maximum height of 100 microns.

34. The method of claim 31, wherein the molding apparatus comprises a mold upper portion and a mold lower portion particularly adapted to mate with one another, and wherein the mold upper portion further comprises a plurality of movable supports that define forming surfaces that define the concave geometric shape with the first surface.
